(19) United States
(12) Patent Application Publication
(10) Pub. No.: US 2009/0264241 A1
(43) Pub. Date: Oct. 22, 2009

(54) MULTI-GROUP TRANSMISSION OF A MOTOR VEHICLE

(75) Inventors: Alan DITTRICH, Konstanz (DE); Rayk HOFFMANN, Friedrichshafen (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 12/421,092

(22) Filed: Apr. 9, 2009

(30) Foreign Application Priority Data
Apr. 16, 2008 (DE) 10 2008 001 201.7

(51) Int. Cl. F16H 37/06

(52) U.S. Cl. 475/209

(57) ABSTRACT

The invention relates to a multi-group transmission of a motor vehicle with at least two transmission groups (2, 3) arranged in a drive train, in which the means for switching an intermediate gear are provided, in order to diminish or avoid interruptions in tractive force during gear changes. A planetary transmission (41) is arranged between a first transmission group (2) and a second transmission group (3), in order to enable gear changes without interruptions in tractive force with a variably selectable intermediate gear, as well as efficient operation that involves as little wear as possible, whereby a transmission input shaft (17) can be brought into a functional connection with a transmission main shaft (30) via the planetary transmission (41). According to a method of operating the multi-group transmission, a functional connection is established between a transmission input shaft (17) and a transmission main shaft (30), in order to switch an intermediate gear with the help of a planetary transmission (41) which can be engaged by means of the associated clutches (46, 47), so that at least one main group (3) is load-free, when a starting element (7) arranged between a drive motor and the transmission main shaft (17) is at least partially closed, an engaged initial gear is disengaged, the rotational speed of the drive motor in a slippage mode of at least one of the clutches (46, 47) of the planetary transmission (41) is synchronized with a connecting rotational speed of a target gear, and, when the connecting rotational speed is reached, a target gear is engaged, and the planetary transmission (41) is one again deactivated.

This application claims priority from German patent application serial no. 10 2008 001 201.7 filed Apr. 16, 2008.

### FIELD OF THE INVENTION

The invention relates to a multi-group transmission of a motor vehicle and a method of operating a multi-group transmission of a motor vehicle.

### BACKGROUND OF THE INVENTION

Multi-group transmissions are comprised of one or more transmission groups that are usually serially arranged, by means of whose combination a large number of gears can be realized. They are increasingly conceived as automated manual transmissions, consisting, for example, of an input group, a main group, and a downstream group. Transmissions of this kind are used particularly in commercial vehicles, since they offer particularly fine gear shifting with 12 or 16 gears, for example, and feature a high degree of efficiency. With a smaller number of gears, configurations consisting only of a main group and an input group or a main group and a downstream group are also possible. In addition, compared to manual transmissions these transmissions are characterized by great operating comfort, and compared to automatic transmissions they are particularly economical in terms of both manufacturing and operating costs.

Because of their type of construction, conventional multi-group transmissions, like all manual or automated transmissions that do not shift when under load, are subject to an interruption of traction during gear shifting, because the power flow from the drive motor is interrupted by disengaging a clutch to engage the gear without load, synchronizing the transmission and the drive motor at one coupling rotational speed in a neutral position, and engaging the target gear. This imposes restrictions on driving performance, due to a loss of speed, and possibly greater fuel consumption. Although in passenger cars, interruptions in traction are, as a rule, more likely to have only a bothersome effect on driving dynamics, for example with a sporty driving style, in the case of heavy commercial vehicles, driving speed on an uphill incline can be slowed to such an extent that upshifting becomes impossible, leading to undesirable downshifting procedures, driving at a crawl, or even to additional start-up procedures.

That is why solutions have already been proposed, in order to reduce or completely avoid these interruptions in traction. An automated multi-group transmission of this kind is known from DE 10 2006 024 370 A1 of the applicant which has a splitter group as an input transmission, a main transmission, and a range change group as an output or downstream transmission. The construction of the known multi-group transmission with the input transmission and the main transmission enables the shifting of a direct gear as an intermediate gear during a gearshift. To do this a direct connection of an input shaft of the input transmission is established with a main shaft of the main transmission by means of a powershift. In that way the main transmission and the splitter group are load-free, so that the selected gear can be disengaged, the transmission synchronized, and the target gear engaged, while the starting clutch remains engaged. Here the powershift clutch transmits an engine torque to the transmission output, whereby a dynamic torque that is being released is used during a rotational speed between the initial gear and the target gear, in order to compensate to a large extent for the interruption in tractive force. The powershift clutch according to DE 10 2006 024 370 A1 can be arranged between the input transmission and the main transmission or between the starting clutch and the input transmission. The gear transmission ratio of the intermediate gear is therefore determined as a direct gear by the direct connection of in the input shaft to the main shaft.

Another multi-group transmission is known from DE 10 2005 046 894 A1 of the applicant. This transmission is comprised of a main transmission and a downstream range change group. A drive motor can be connected to the engine-side end of a transmission input shaft by means of a starting or engine clutch. The transmission input shaft, in turn, can be put into functional connection with an output shaft of the transmission by means of a powershift clutch that is arranged inside the range change group. Here, the opposite end of the transmission input shaft is connected to an input-side of the powershift clutch, and an output shaft of the main transmission is coupled to an output side of the of powershift clutch. The range change group is designed as a planetary transmission, whereby the output shaft is connected to a planetary carrier and the output side of the powershift clutch via a sun gear and a planetary gear set carried by the planetary carrier is coupled to the output shaft. In this way, an interruption in tractive force can be avoided during a shifting procedure of the main transmission. In order to avoid an interruption in tractive force during a range change shift by the range change group, the output side of the powershift clutch can also be directly connected to the planetary carrier and in that way with the output shaft. In that way shifting procedures which involve a range change shift are supported with tractive force.

Known from DE 197 41 440 A1 is a gearbox in which a single group multi-step transmission with a countershaft design for enabling an automatic mode is combined with an epicyclic transmission, preferably a planetary transmission, in order to avoid complete interruption in tractive force when changing gears. A fixed wheel is arranged at the input end which meshes with a fixed wheel of a countershaft, therefore permanently driving it. In addition, the idler gears for the gear ratios provided for in the multi-step transmission are found on the countershaft and mesh with the assigned fixed wheels on an output shaft.

The planetary transmission is interposed in the power train parallel between the drive shaft and output shaft. The sun gear is thereby connected to the transmission-side end of the drive shaft. The ring gear can be coupled via a first locking mechanism to a transmission housing and can be coupled via a friction clutch with the output shaft, whereby the input side of the friction clutch is connected to the ring gear, and the output side of the clutch is connected with the output shaft.

The planetary carrier can be connected alternately to the transmission housing and the output shaft by means of a second locking mechanism.

In this known transmission the planetary transmission fulfils a plurality of functions. On the one hand, it serves the realization of at least one gear step and a reverse gear during normal driving operation. In particular, it enables the shifting of a direct gear by means of a direct coupling of the drive shaft with the output shaft, whereby the planetary transmission components are interlocked with each other. Secondly, it replaces a conventional starting element, possibly with an additional retaining function on uphill grades, and is actuated by performing shifting procedures. During a change of gears the friction clutch is actuated in a dosed slip depending on the shifting position of the planetary gearwheels, in order to provide the exact adjustment of a torque transmitted to the output shaft, so that the loose wheels on the countershaft which have to be switched for the gear change can be switched without load.

It is considered disadvantageous, that, even though the tractive force during a shifting procedure of the known transmission is not completely interrupted, the torque transmitted to the output shaft does drop. Furthermore, a friction clutch is subjected to great strain because it functions as both a starting element and a powershift element, particularly during the frequent starting and shifting procedures that normally occur in heavy commercial vehicles with multi-group transmission, which requires correspondingly elaborate dimensions and cooling. Because some driving gears are realized via the planetary transmission, the transmission is a combination of conventional transmission and automatic transmission in which the degree of transmission efficiency, compared to an automated manual transmission, tends to be lower.

### SUMMARY OF THE INVENTION

Against this background, the object of the invention is to disclose a multi-group transmission and a method for operating it which enables gear shifting that is largely free of interruption in tractive force with a variably selectable intermediate gear, as well as guaranteeing efficient and low-wear operation.

The invention is based on the knowledge, that, in the case of a multi-group transmission with a planetary transmission provided especially for it, intermediate gears of different ratios can be selected during a shifting procedure, which enable particularly efficient and comfortable operation that is also largely free of interruptions in tractive force, particularly in commercial vehicles, which are equipped with it, without having to dispense with the comparatively high degree of efficiency and the fine gear shifting of an automated transmission.

Accordingly, the invention is based initially on a multi-group transmission of a motor vehicle with at least two transmission groups arranged in one drive train, where means are provided of engaging an intermediate gear to diminish or avoid interruptions in tractive force during gear changes. To perform this task the invention provides for a planetary transmission to be arranged between a first transmission group and a second transmission group in order to engage an intermediate gear, whereby a transmission input shaft can be brought into a functional connection with a transmission main shaft via the planetary transmission.

Understood as a change of gear is a shifting procedure during which an initial gear is disengaged and a target gear engaged, whereby the special case is also included in which the target gear corresponds to the initial gear, namely when no change in gear ratio takes place.

Furthermore, the invention is based on a method of operating a multi-group transmission of a motor vehicle with at least two transmission groups arranged in a power train, in which during a gear change an intermediate gear is engaged to diminish or avoid an interruption in tractive force. The task set for the method is accomplished in that a functional connection is established between a transmission input shaft and a transmission main shaft to engage an intermediate gear when shifting gears aided by a planetary transmission which can be engaged by means of couplings belonging to it, so that at least one main group of the transmission with an at least partially closed starting element which is arranged between a drive motor and the transmission input shaft is load-free, and that subsequently an engaged initial gear is disengaged, the rotational speed of the drive motor in slip operation is synchronized with a connecting rotational speed of the target gear, and, when the connecting rotational speed is reached, a target gear is engaged and the planetary transmission is once again deactivated.

The inventive arrangement is particularly advantageous in the case of a multi-group transmission for commercial vehicles in which three transmission groups are provided for, whereby an upstream two-gear splitter group that is assigned to the transmission input shaft and a central multi-gear main group that is assigned to the transmission main shaft are designed as a countershaft transmission, and a downstream range change group is designed as a planetary transmission.

The transmission main shaft runs through the transmission as the central shaft and is directly or indirectly connected to an output shaft via which the transmitted torque flows to the driven vehicle wheels. The planetary transmission for shifting the intermediate gear is inserted in the invention between the transmission input shaft and the transmission main shaft.

It can be advantageously realized that on the drive side the sun gear of the planetary transmission is connected to the transmission input shaft, and that on the output side the planetary carrier and the ring gear can each be connected by means of a coupling associated with the transmission main shaft. The clutch input sides are thereby connected with the planetary carrier or, as the case may be, the ring gear, and the clutch output sides are connected coaxially one after the other with the transmission main shaft.

Furthermore, the ring gear can be coupled via a brake device with a housing, in particular a transmission housing. Since the planetary transmission is preferably only used for shifting the intermediate gear when changing gears and it does not replace in particular a starting element, it can be relatively cost-efficiently and compactly implemented in the multi-group transmission.

The planetary transmission can also feature a plus-planetary gear set with inner and outer planetary gears instead of the conventional minus-planetary gear set, whereby the internal planetary gears mesh, on the one hand, with a sun gear and, on the other, with the external planetary gears, and the external planetary gears mesh, on the one hand, with a ring gear and, on the other, with the internal planetary gears. In this case the functions of ring gear and planetary carrier would be interchangeable, i.e. the power flow could branch off via the ring gear to the transmission housing, and the planetary carrier could be braked.

During normal driving operation with an engaged gear, the clutches of the planetary transmission are disengaged, so that the planetary transmission is deactivated and the torque flow from the drive motor is transmitted, branching out via a conventional starting element, the transmission input shaft, and the countershafts corresponding to the engaged gear wheels of the gear groups, past the planetary transmission to the transmission main shaft, and from there to the output.

During a change of gears the intermediate gear is connected, when, in the case of one planetary transmission with a conventional minus-planetary gear set, at least the clutch of the planetary gear carrier is partially engaged. In that way the power flow is directed from the transmission input shaft to the transmission main shaft, leaving out the main transmission, so that a functional connection is established between the drive and the output via the planetary transmission, and the main transmission is at the same time load-free and therefore shiftable.

The engaged initial gear is subsequently disengaged, whereby the starting element can remain completely engaged, so that the tractive force is maintained.

The active coupling of the planetary transmission is then held in the slip mode during the pull upshift or downshift of the engine torque of the drive motor against the transmission main shaft, and thus against the output. During this process the rotational speed of the engine is adjusted to the required target gear, namely, lowered, for example, during an upshifting procedure and the target gear is engaged when the synchronous rotational speed is reached. Finally, the planetary transmission is once again separated from the transmission main shaft. In principle, gear changes supported by a tractive force with gear transitions over two or more gear steps are also possible.

Supporting the torque at the output by means of the intermediate gear largely avoids a loss of vehicle speed during a shifting procedure. Since the main transmission and the splitter transmission are made immediately load-free during a shifting demand of a transmission control by means of the planetary transmission, and the synchronization can be initiated on the target gear, and it is, in particular, not necessary to wait for the uncoupling of the starting element, the required shifting duration for the shift change can also be reduced. Furthermore, the vibration and switching impacts in the drive train can be vastly reduced, because the drive train always remains pre-stressed by means of the intermediate gear during the gear change. In addition, a transmission brake can be dispensed with, because the rotating masses which are to be synchronized can be braked by the intermediate gear during the gear change, which is additionally cost-efficient and saves installation space and weight.

The intermediate gear can advantageously be optionally shifted as a direct gear or as a gear ratio by means of the appropriate shifting positions of the planetary transmission. Either the planetary wheel carrier or the planetary wheel carrier together with the ring gear can transmit a torque of the drive motor acting on the transmission input shaft to the transmission main shaft via the two clutches that are preferably configured as friction clutches. For this purpose, the ring gear can alternatively be braked on a housing or, as the case may be, released and coupled to the transmission main shaft by means of its associated coupling. The planetary wheel carrier can be coupled by means of the coupling associated with it to the transmission main shaft, whereby the clutch can be controlled during slippage.

In particular, it can be provided that the intermediate gear is shifted as a direct gear, whereby the planetary gear carrier of the planetary transmission can be coupled via the first associated clutch and the ring gear of the planetary transmission via the second associated clutch to the transmission main shaft. Once the ring gear clutch is engaged and the planetary gear carrier is transferring the drive torque via the at least partially engaged planetary carrier clutch to the drive, the planetary transmission wheels are blocked, i.e. no relative movements are possible between the planetary gear carrier and the ring wheel. Consequently, the entire planetary transmission rotates at the rotational speed of the transmission input shaft, thus—with a completely engaged starting element—at the engine speed, and transmits the applying torque to the transmission main shaft in the direct ratio i=1.

It is particularly advantageous that the intermediate gear can also be shifted as a gear ratio, whereby the planetary carrier is coupled with the transmission main shaft via the clutch associated with it and the ring gear of the planetary transmission is uncoupled from the transmission main shaft and coupled via a braking device with a housing. The planetary carrier clutch can hereby be advantageously operated with slippage, whereby the degree of engagement can advantageously be regulated with a clutch control. If required, the ring gear can be made to freewheel by disengaging the associated clutch and releasing the break.

A particularly high shifting comfort is achieved with the variably selectable intermediate gear. Furthermore, it also allows for flexible adjustment of the selection of the intermediate gear to different driving situations, depending, for example, on the upward grade of the roadway, the current total weight and/or the driving speed.

In the arrangement with a downstream range change group in planetary construction, shifting the range change transmission between two gear ranges by means of a shifting device that couples the ring gear either with a housing (lower gear step) or with the planetary carrier (upper gear step), is not, from the outset, supported by torque. In order to enable torque-assisted shifting of the range change group as well, the transmission main shaft can be passed through the range change transmission, for example, and directly connected to the output shaft, so that the intermediate gear can be shifted as a direct gear of the overall transmission, independently of the shifting position or a shifting position change of the range change group. A range change group that is configured to be shifted under load is also possible. For inclusion of a range change group in the torque-support of the intermediate gear, we refer at this point to the DE 10 2005 046 894 A1 cited above.

### BRIEF DESCRIPTION OF THE DRAWINGS

For the purpose of clarifying the invention, a drawing with one embodiment has been added to the description. It shows in:

FIG. 1 A transmission diagram of a multi-group transmission of a motor vehicle with a planetary transmission for connecting an intermediate gear,

FIG. 2 A torque flow of the transmission according to FIG. 1 with an intermediate gear engaged for direct torque transmission, and

FIG. 3 A torque flow of the transmission according to FIG. 1 with an intermediate gear engaged for transmission of a ration of torque.

### DETAILED DESCRIPTION OF THE PREFERRED EMBODIMENTS

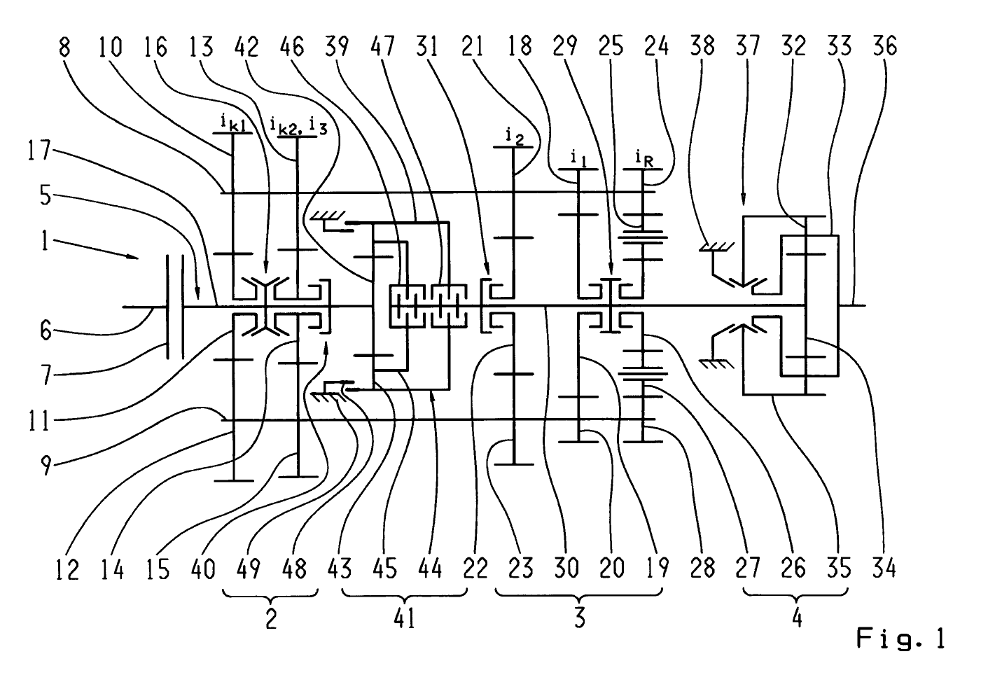

FIG. 1 accordingly shows an automated manual multi-group transmission configured as a dual-shaft transmission 1 with two parallel, rotatably mounted countershafts 8, 9 and three transmission groups 2, 3, 4, arranged one after the other, as could be provided, for example in the drive train of a truck. This kind of transmission as such, that is, without intermediate gear shifting, is known, for example, from the type series ZF-AS Tronic, and with intermediate gear coupling from DE 10 2006 024 370 A1 of the applicant, as cited at the beginning. A conventional starting element 7 in the form of a clutch is arranged between a drive shaft 6 of a drive motor that is not depicted in more detail and a transmission input 5. The transmission group 2, arranged at the transmission input 5, is designed as a dual-gear splitter transmission. The second transmission group 3 forms a three-gear main transmission. A dual-gear range change group is arranged downstream as a third transmission group 4.

The splitter transmission 2 features two gear constants iₖ₁, iₖ₂, each of which comprises a fixed wheel 10, 12 or, as the case may be, 13, 15, which is mounted in a rotationally fixed manner on the first countershaft 8 and on the second countershaft 9, and which meshes with a loose wheel 11 or, as the case may be, 14. In order to shift the gear constants iₖ₁, iₖ₂, a switching device 16 is advantageously provided with a synchronization, by means of which the loose wheel 11 or, as the case may be, 14 can be selectively connected in a rotationally-fixed manner with a transmission input shaft 17.

The main transmission 3 has three forward gears i₁, i₂, and i₃, as well as a reverse gear iᵣ. The 1^{st} gear and the 2^{nd} gear are each comprised of two fixed wheels 18, 20 or, as the case may be, 21, 23 and a loose wheel 19 or, as the case may be, 22. The 3^{rd} gear is realized together with the second gear constant iₖ₂ of the splitter transmission 2. The reverse gear is comprised of two fixed wheels 24, 28, one loose wheel 26, and two rotatably mounted intermediate wheels 25, 27 which mesh, on the one hand, with the respectively associated fixed wheel 24 or, as the case may be, 28 and, on the other hand, with the loose wheel 26.

In order to engage the 1^{st} gear and the reverse gear, a shift arrangement 29 is provided with a shift clutch, by means of which the associated loose wheels 19 or, as the case may be, 29 can be selectively connected to a transmission main shaft 30 in a rotationally-fixed manner. In order to engage the 2^{nd} gear, a shift clutch arrangement 31 is provided, by means of which the associated loose wheel 22 can be coupled in a rotationally-fixed manner with the transmission main shaft 30. An additional shift clutch arrangement 40 is provided for engaging the 3^{rd} gear at the splitter transmission 2. This shift clutch arrangement 40 selectively connects the associated loose wheel 14 in a rotationally-fixed manner with the transmission input shaft 17.

The downstream range change transmission 4 is designed as a planetary transmission. Therein a planetary gear set 32 is guided by a planetary carrier 33. The planetary gears mesh, on the one hand, with a central sun gear 34 and, on the other, with an external ring gear 35. The sun gear 34 is connected to the transmission main shaft 30. The planetary carrier 33, in turn, is connected to a transmission output shaft 36. In order to shift the range change transmission 4, a shift arrangement 37 is advantageously provided with synchronization. This shift arrangement 37, in a first shifting position, connects the ring gear 35 with a housing 38, or in a second shifting position, locks the ring gear 35 with the planetary carrier 33.

The combination of the transmission groups 2, 3 and 4 of the transmission diagram shown produces a total of 2×3×2=12 gears. The power flow of the transmission 1 branches after a switching sequence during which, starting with the 1^{st} gear in the main transmission 3, and then alternating, there is shifting through the splitter transmission 2 and the main transmission 3, so that one after the other, 2×3=6 gears of a lower gear range “1^{st} gear to 6^{th} gear” is shifted. Once the 6^{th} gear is reached, there is a changeover to the range change transmission 4, and there is again shifting alternately through the main transmission 3 and the splitter transmission 2, so that again there is shifting through 2×3=6 gears, however, now in an upper range “7^{th} gear to 12^{th} gear.” The upstream splitter transmission 2 also alternatingly shifts the reverse gear ration I_{R}, so that in addition two reverse gears are available.

A planetary transmission 41 is arranged between the transmission input shaft 17 and the transmission main shaft 30, in order to shift an intermediate gear. As a planetary transmission input, the transmission input shaft 17 is connected to a sun gear 42. A negative planetary gear set 43, preferably with three or more planetary gears, meshes, on the one hand, with the sun gear 42 and, on the other, with a sun gear 44. The planetary gear set 43 is mounted on a planetary carrier 45.

A first clutch 46 designed as a friction clutch is arranged on the planetary carrier 45, whereby its input side is connected to the planetary carrier 45 and its output side with the transmission main shaft 30. A second clutch 47, advantageously designed as a friction clutch, is arranged on a ring gear 44, whose input side is connected to an output-side axial extension 39 of the ring gear 44, and whose output-side is in turn connected to the transmission main shaft 30, so that the two friction clutches 46, 47 are arranged coaxially one after the other. The planetary carrier 45 and/or the ring gear 44 can therefore be selectively connected to the transmission main shaft 30 via the friction clutches 46, 47.

The ring gear 44 can also be braked or locked on a housing 49 by means of a braking device 48. In the example shown, the braking device 48 is realized with a friction partner on a drive-side axial extension of the ring gear 44 which corresponds with a friction partner on the housing 49. The housing 49 for locking the ring gear 44 of the intermediate planetary transmission 41 and the housing 38 for locking the ring gear 35 of the downstream range change planetary transmission 4 can be parts of a common transmission housing of the transmission 1.

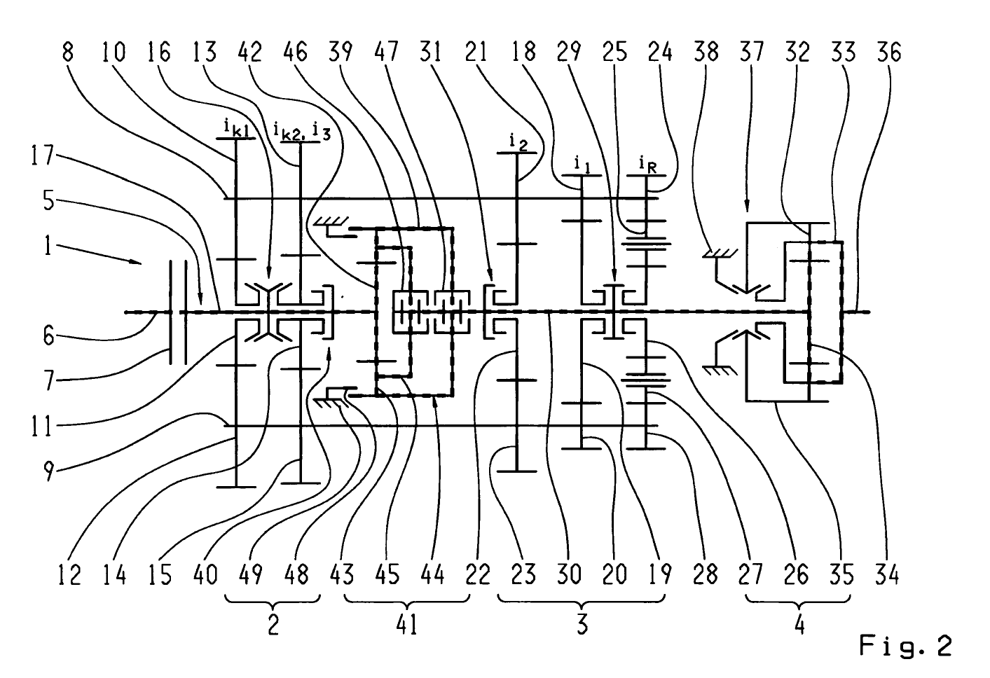

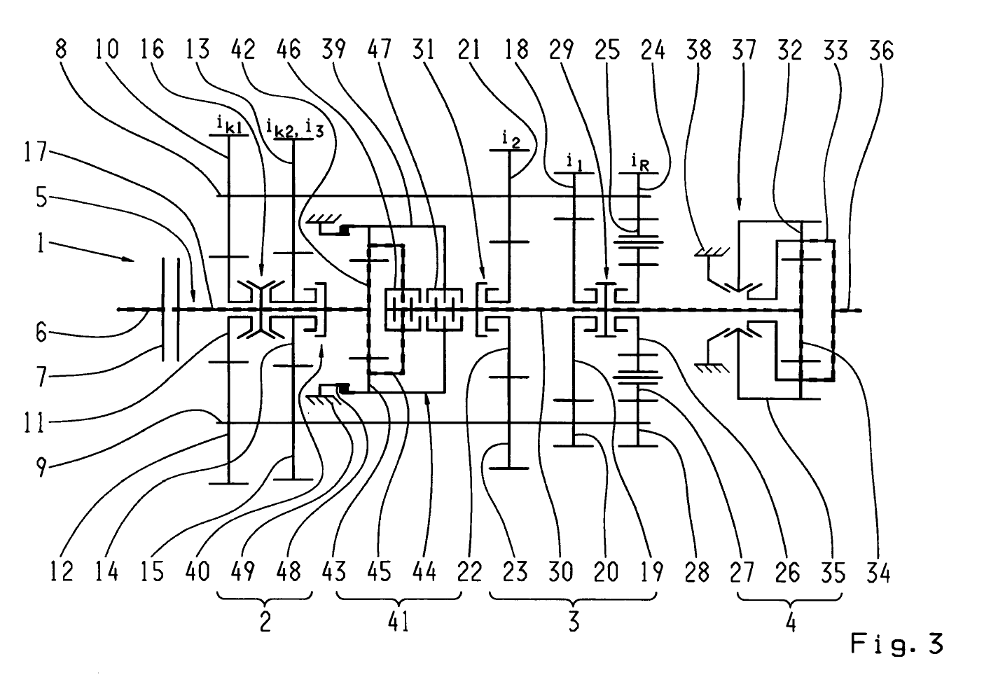

The function of the intermediate-gear shift arrangement is explained using FIG. 2 and FIG. 3, in which each torque flow—emphasized by a dashed line—is presented in a transmission diagram according to FIG. 1.

When there is a shift demand during a driving operation, the starting element 7 remains completely engaged. The intermediate gear is thereby connected. This takes place—in the case of the described negative planetary gear set 43—in that at least the clutch 46 of the planetary carrier 45 is actuated in the engagement direction, so that in the slippage mode, the engine torque of the drive engine is transmitted from the transmission input shaft 17 to the transmission main shaft 30.

Since the transmission main shaft 30 is connected via the range change group 4 with the transmission output shaft 36, the engine torque is braced on the output and also via the driven vehicle wheels on the roadway. Consequently the main transmission 3 and the splitter transmission 2 are load-free and can therefore be shifted, despite an engaged starting element 7.

According to the example in FIG. 2, engagement of the intermediate gear takes place in that both the clutch 46 of the planetary carrier 45 and the clutch 47 of the ring gear 44 are actuated in the engagement direction, so that both the planetary gear carrier 45 and the ring gear 44 transmit a torque, and the entire planetary transmission 41 rotates at the transmission input rotational speed. The intermediate gear is therefore connected as a direct gear. The splitter transmission 2 and the main transmission 3 are not involved in the intermediate gear. The torque flow runs from the drive shaft 6 via the starting element 7, the transmission input shaft 17 via the planetary transmission 41 to the transmission main shaft 30. The downstream range change transmission 4 transmits the output torque via its planetary carrier 32 to the transmission output shaft 36, whereby the shifting position of the associated shifting device 37 must be taken into account.

In the example shown in FIG. 3, the ring gear clutch 47 is, however, completely disengaged, and the ring gear 44 with the braking device 48 is locked on the housing 49, i.e. held in place. Accordingly, the planetary gears, driven by the sun gear 42 that is connected to the transmission input shaft 17, roll up on the ring gear 44, by means of which the planetary carrier 45 which is connected via the sliding clutch 46 to the transmission main shaft 30 is moved in the same direction, in the direction of rotation of the transmission input shaft 17, and a torque with a positive ration is transmitted to the output.

The tractive force is maintained during the disengagement of the original gear by means of the torque support of the intermediate gear. During the shifting procedure the active planetary transmission clutch 46 is actuated in the slippage mode, so that it subsequently braces the torque of the drive motor by means of the functional connection with the transmission output shaft 36 to the roadway. The rotational speed of the engine is lowered during the torque support to a synchronous rotational speed of a target gear. The torque released by the reduction in rotational speed is thus used as compensation for the interruption in tractive force during the neutral position. As soon as the synchronous rotational speed is reached, the target gear is engaged in the main transmission 3, and the splitter group 2 is shifted, if necessary, via an interim neutral position into the new or previous gear-constant which corresponds to the shifting sequence or, as the case may be, the selected gear transition. Then the planetary transmission clutch 46 and, if the direct ration was shifted, the ring gear clutch 47 is re-disengaged which uncouples the planetary transmission 41 in the power flow from the drive train. The torque-supported gear change is then complete.

### LIST OF REFERENCE NUMBERS

1 Dual countershaft transmission
2 Splitter transmission
3 Main transmission
4 Range change group
5 Transmission input
6 Drive shaft
7 Starting element
8 Countershaft
9 Countershaft
10 Fixed wheel
11 Loose wheel
12 Fixed wheel
13 Fixed wheel
14 Loose wheel
15 Fixed wheel
16 Switching device
17 Transmission input shaft
18 Fixed wheel
19 Loose wheel
20 Fixed wheel
21 Fixed wheel
22 Loose wheel
23 Fixed wheel
24 Fixed wheel
25 Intermediate gear
26 Loose wheel
27 Intermediate gear
28 Fixed wheel
29 Shift clutch
30 Transmission main shaft
31 Shift clutch
32 Planetary gear set
33 Planetary carrier
34 Sun gear
35 Ring gear
36 Transmission output shaft
37 Shift arrangement
38 Housing
39 Ring gear extension
40 Shift clutch arrangement
41 Intermediate gear planetary transmission
42 Sun gear
43 Planetary gear set
44 Ring gear
45 Planetary carrier
46 Planetary carrier clutch, first clutch
47 Ring gear clutch, second clutch
48 Brake device
49 Housing
i_{K1} Splitter transmission-gear constant
i_{K2} Splitter transmission-gear constant
i₁ Main transmission-gear
i₂ Main transmission-gear
i₃ Main transmission-gear
i_{R} Main transmission-reverse gear

1-10. (canceled)

11. A multi-group transmission for a motor vehicle with at least firs and second transmission groups (2, 3) arranged in a drive train,
the transmission having an intermediate gear switching means for at least reduce interruptions in tractive force when changing gears,
a planetary transmission (41) being arranged to switch an intermediate gear between a first transmission group (2) and a second transmission group (3), and
the planetary transmission (41) having a transmission input shaft (17) that is operatively connectable with a transmission main shaft (30).

12. The multi-group transmission according to claim 11, wherein a sun gear (42) of the planetary transmission (41) is connected to the transmission input shaft (17), and a planetary carrier (45) and a ring gear (44) of the planetary transmission (41) are respectively coupled, via a first clutch (46) and a second clutch (47), to the transmission main shaft (30).

13. The multi-group transmission according to claim 12, wherein a brake device (48) facilitates engagement of the ring gear (44) with a housing (49).

14. The multi-group transmission according to claim 11, wherein the intermediate gear is selectively switched, via corresponding shift positions of the planetary transmission (41), as one of a direct gear and as a ratioed gear.

15. The multi-group transmission according to claim 11, wherein the planetary transmission (41) is a negative-planetary gear set (43).

16. The multi-group transmission according to claim 12, wherein the planetary transmission has a plus-planetary gear set mounted radially between a sun gear and a ring gear with internal and external planetary gears, the internal planetary gears mesh with the sun gear and with the external planetary gears, and the external planetary gears mesh with the ring gear and the internal planetary gears.

17. The multi-group transmission according to claim 11, wherein the multi-group transmission has three transmission groups (2, 3, 4), the first transmission group (2) is an upstream dual-gear splitter group (2) which is assigned to the transmission input shaft (17), the second transmission group (3) is a central multi-gear main group (3) which is assigned to the transmission main shaft (30), the first and the second transmission groups (2, 3) are each a countershaft transmission, and the third transmission group (4) is a downstream range change group which is a planetary transmission.

18. A method of operating a multi-group transmission of a motor vehicle having at least first and second transmission groups (2, 3) arranged in a drive train, in which an intermediate gear is switched, during a gear change for diminishing or avoiding interruptions in tractive force, to switch an intermediate gear when changing a gear with the help of a planetary transmission (41) which can be engaged using the associated first and second clutches (46, 47), the method comprising the steps of:
establishing an operative connection between a transmission input shaft (17) and a transmission main shaft (30) so that at least one main group (3) is load-free with an at least partially engaged starting element (7) located between a drive motor and the transmission input shaft (17) to disengage initial gear;
as a result of disengagement of an engaged initial gear, synchronizing a rotational speed of the drive motor, in a slip mode of at least one of the first and the second clutches (46,47) of the planetary transmission (41), with a connecting rotational speed of a target gear; and
after the connecting rotational speed is reached, engaging a target gear and once again disengaging the planetary transmission (41).

19. The method according to claim 18, further comprising the step of shifting the intermediate gear as a direct gear, whereby a planetary carrier (45) of the planetary transmission (41) is coupled with the transmission main shaft via an associated first clutch (46) and a ring gear (44) of the planetary transmission (41) by an associated second clutch (47).

20. The method according to claim 18, further comprising the step of shifting the intermediate gear as a ratioed gear, whereby the planetary carrier (45) is coupled, via the first clutch (46) associated with it to the transmission main shaft (30), and the ring gear (44) of the planetary transmission (41) is uncoupled from the transmission main shaft (30) and is coupled with a housing (49) via a braking device (48).
